(19) United States
(12) Patent Application Publication
(10) Pub. No.: US 2021/0405486 A1
(43) Pub. Date: Dec. 30, 2021

(54) PIXEL STRUCTURE, PIXEL CIRCUIT, AND DISPLAY PANEL

(71) Applicant: TCL CHINA STAR OPTOELECTRONICS TECHNOLOGY CO., LTD., Shenzhen (CN)

(72) Inventor: Ling ZHAO, Shenzhen (CN)

(73) Assignee: TCL CHINA STAR OPTOELECTRONICS TECHNOLOGY CO., LTD., Shenzhen (CN)

(21) Appl. No.: 16/650,410

(22) PCT Filed: Mar. 6, 2020
(86) PCT No.: PCT/CN2020/078106

§ 371 Date: Mar. 25, 2020

(51) Int. Cl. G02F 1/1362; G02F 1/1368

(52) U.S. Cl. CPC G02F 1/136286; G02F 1/136213; G02F 1/1368

(57) ABSTRACT

The present application provides a pixel structure, a pixel circuit, and a display panel. The pixel structure includes: a first metal layer including gates of thin film transistors and a gate common electrode line; a second metal layer including sources and drains of the thin film transistors; wherein a drain of a shared thin film transistor is connected to the common electrode line. The pixel structure prevents a series of problems such as existence of a shared electrode line in a conventional pixel structure affecting an aperture ratio, white fog, a short circuit to a data line easily to occur, not easy to overhaul, etc.

### FIELD OF INVENTION

The present application relates to the display field, and especially to a pixel structure, a pixel circuit, and a display panel.

### BACKGROUND OF INVENTION

Vertically aligned liquid crystal display panels have very high contrast in comparison with other kinds of liquid crystal display panels, and have a very broad applications in the large size display field. However, at wide viewing angles, there currently exists a visual color difference or visual color shifting of the vertically aligned liquid crystal display panels.

In order to improve the visual color difference or visual color shifting of the vertically aligned liquid crystal display panels at wide viewing angles, conventional technology adopts a three-thin-film-transistor (3T) structure pixel design on an array substrate side. As shown in FIG. 1, a pixel structure is divided into two parts of a main pixel area and a sub-pixel area, and voltage of the sub-pixel area is decreased through a shared thin film transistor 101, thereby controlling a difference of liquid crystal rotation of the main pixel area and the sub-pixel area, and improving the visual color shifting phenomenon of the display panels at wide viewing angles.

The decreased sub-pixel voltage is directed out through a shared electrode line 102. However, arrangement of the shared electrode line 102 will increase a line width of a gate common electrode line 103 located below it, and decrease an aperture ratio of the display panels. A manufacturing process of the shared electrode line 102 will affect and make the display panels very easily occur a white fog phenomenon. A smaller distance between the shared electrode line 102 and a data line 104 very easily causes a short circuit risk. It is not easy to overhaul when one shared electrode line 102 is connected to a row of shared thin film transistors, which very easily causes problems of sharing failure of a whole row of pixels.

### SUMMARY OF INVENTION

The present application provides a pixel structure, pixel circuit, and display panel to improve a series of technical problems such as existence of a shared electrode line in a pixel structure of a conventional liquid crystal display panel affecting an aperture ratio, white fog, a short circuit to a data line easily to occur, a sharing failure of a whole row of pixels, etc.

In order to resolve the above-mentioned problems, the present application provides the following technical approach.

The present application provides a pixel structure that includes: a first metal layer including a scan line, a gate of a first thin film transistor, a gate of a second thin film transistor, a gate of a third thin film transistor, and a gate common electrode line, wherein the gate common electrode line includes a first gate common electrode line and a second gate common electrode line; a second metal layer including a data line, a source and a drain of the first thin film transistor, a source and a drain of the second thin film transistor, and a source and a drain of the third thin film transistor; a pixel electrode layer disposed on one side of the second metal layer away from the first metal layer and including a main pixel electrode and a sub-pixel electrode; wherein the main pixel electrode is connected to the drain of the first thin film transistor, the sub-pixel electrode is connected to the drain of the second thin film transistor and the source of the third thin film transistor, and the drain of the third thin film transistor is connected to the gate common electrode line.

In a pixel structure according to the present application, the drain of the third thin film transistor is connected to the first gate common electrode line.

In a pixel structure according to the present application, the drain of the third thin film transistor is connected to the second gate common electrode line.

In a pixel structure according to the present application, the scan line is insulated from the gate common electrode line, and the data line is connected to the source of the first thin film transistor and the source of the second thin film transistor.

In a pixel structure according to the present application, the first metal layer further includes a first electrode plate of a first storage capacitor and a first electrode plate of a second storage capacitor, and the second metal layer further includes a second electrode plate of the first storage capacitor and a second electrode plate of the second storage capacitor, and wherein the drain of the first thin film transistor is connected to the second electrode plate of the first storage capacitor, and the drain of the second thin film transistor is connected to the second electrode plate of the second storage capacitor.

In a pixel structure according to the present application, the pixel structure further includes an active layer and an insulating layer, wherein the active layer is disposed between the first metal layer and the second metal layer, and the insulating layer is disposed between the first metal layer and the active layer.

In a pixel structure according to the present application, a via hole is formed in the insulating layer, and the drain of the third thin film transistor is connected to the gate common electrode line through the via hole.

In a pixel structure according to the present application, the pixel structure further includes an active layer, a first insulating layer, and a second insulating layer, wherein the active layer is disposed on one side of the first metal layer away from the second metal layer, the first insulating layer is disposed between the first metal layer and the active layer, and the second insulating layer is disposed between the first metal layer and the second metal layer.

In a pixel structure according to the present application, a via hole is formed in the second insulating layer, and the drain of the third thin film transistor is connected to the gate common electrode line through the via hole.

The present application provides a pixel circuit that includes a first thin film transistor, a second thin film transistor, a third thin film transistor, a first storage capacitor, a first liquid crystal capacitor, a second storage capacitor, and a second liquid crystal capacitor, wherein a drain of the first thin film transistor is connected to the first storage capacitor and the first liquid crystal capacitor, and a drain of the second thin film transistor is connected to the second storage capacitor, the second liquid crystal capacitor, and a source of the third thin film transistor, and wherein a gate of the first thin film transistor, a gate of the second thin film transistor, and a gate of the third thin film transistor are connected to a same scan line and input a same scan electrical signal, a source of the first thin film transistor and a source of the second thin film transistor are connected to a same data line and input a same data electrical signal, and a source of the third thin film transistor is input a gate common signal.

Meanwhile, the present application further provides a display panel that includes a pixel structure, and the pixel structure includes: a first metal layer including a scan line, a gate of a first thin film transistor, a gate of a second thin film transistor, a gate of a third thin film transistor, and a gate common electrode line, wherein the gate common electrode line includes a first gate common electrode line and a second gate common electrode line; a second metal layer including a data line, a source and a drain of the first thin film transistor, a source and a drain of the second thin film transistor, and a source and a drain of the third thin film transistor; a pixel electrode layer disposed on one side of the second metal layer away from the first metal layer and including a main pixel electrode and a sub-pixel electrode; wherein the main pixel electrode is connected to the drain of the first thin film transistor, the sub-pixel electrode is connected to the drain of the second thin film transistor and the source of the third thin film transistor, and the drain of the third thin film transistor is connected to the gate common electrode line.

In a display panel according to the present application, the drain of the third thin film transistor is connected to the first gate common electrode line.

In a display panel according to the present application, the drain of the third thin film transistor is connected to the second gate common electrode line.

In a display panel according to the present application, the scan line is insulated from the gate common electrode line, and the data line is connected to the source of the first thin film transistor and the source of the second thin film transistor.

In a display panel according to the present application, the first metal layer further includes a first electrode plate of a first storage capacitor and a first electrode plate of a second storage capacitor, and the second metal layer further includes a second electrode plate of the first storage capacitor and a second electrode plate of the second storage capacitor, and wherein the drain of the first thin film transistor is connected to the second electrode plate of the first storage capacitor, and the drain of the second thin film transistor is connected to the second electrode plate of the second storage capacitor.

In a display panel according to the present application, the pixel structure further includes an active layer and an insulating layer, wherein the active layer is disposed between the first metal layer and the second metal layer, and the insulating layer is disposed between the first metal layer and the active layer.

In a display panel according to the present application, a via hole is formed in the insulating layer, and the drain of the third thin film transistor is connected to the gate common electrode line through the via hole.

In a display panel according to the present application, the pixel structure further includes an active layer, a first insulating layer, and a second insulating layer, wherein the active layer is disposed on one side of the first metal layer away from the second metal layer, the first insulating layer is disposed between the first metal layer and the active layer, and the second insulating layer is disposed between the first metal layer and the second metal layer.

In a display panel according to the present application, a via hole is formed in the second insulating layer, and the drain of the third thin film transistor is connected to the gate common electrode line through the via hole.

In a display panel according to the present application, the display panel further includes a pixel circuit, and the pixel circuit includes a first thin film transistor, a second thin film transistor, a third thin film transistor, a first storage capacitor, a first liquid crystal capacitor, a second storage capacitor, and a second liquid crystal capacitor, wherein a drain of the first thin film transistor is connected to the first storage capacitor and the first liquid crystal capacitor, and a drain of the second thin film transistor is connected to the second storage capacitor, the second liquid crystal capacitor, and a source of the third thin film transistor, and wherein a gate of the first thin film transistor, a gate of the second thin film transistor, and a gate of the third thin film transistor are connected to a same scan line and input a same scan electrical signal, a source of the first thin film transistor and a source of the second thin film transistor are connected to a same data line and input a same data electrical signal, and a source of the third thin film transistor is input a gate common signal.

Beneficial effects of the present application is that the present application provides a pixel structure, a pixel circuit, and a display panel. The pixel structure includes: a first metal layer including a scan line, a gate of a first thin film transistor, a gate of a second thin film transistor, a gate of a third thin film transistor, and a gate common electrode line, wherein the gate common electrode line includes a first gate common electrode line and a second gate common electrode line; a second metal layer including a data line, a source and a drain of the first thin film transistor, a source and a drain of the second thin film transistor, and a source and a drain of the third thin film transistor; a pixel electrode layer disposed on one side of the second metal layer away from the first metal layer and including a main pixel electrode and a sub-pixel electrode; wherein the main pixel electrode is connected to the drain of the first thin film transistor, the sub-pixel electrode is connected to the drain of the second thin film transistor and the source of the third thin film transistor, and the drain of the third thin film transistor is connected to the gate common electrode line through a via hole. The pixel structure prevents a series of problems such as existence of a shared electrode line in a conventional pixel structure affecting an aperture ratio, white fog, a short circuit to a data line easily to occur, not easy to overhaul, etc., and simultaneously further mitigates a problem that a drain of a third thin film transistor is connected to a common electrode line on a color filter substrate in the conventional pixel structure, affecting the aperture ratio of a display panel.

### DESCRIPTION OF DRAWINGS

With reference to the following drawings, the technical approach and other beneficial effects of the present application will be obvious through describing embodiments of the present application in detail.

FIG. 1 is a top structural schematic diagram of a conventional pixel structure.

FIG. 2 is a first top structural schematic diagram of a pixel structure according to an embodiment of the present application.

FIG. 3 is a second top structural schematic diagram of a pixel structure according to an embodiment of the present application.

FIG. 4 is a second top structural schematic diagram of a pixel structure according to an embodiment of the present application.

FIG. 5 is a first sectional schematic diagram of a pixel structure according to an embodiment of the present application.

FIG. 6 is a second sectional schematic diagram of a pixel structure according to an embodiment of the present application.

FIG. 7 is a pixel circuit diagram according to an embodiment of the present application.

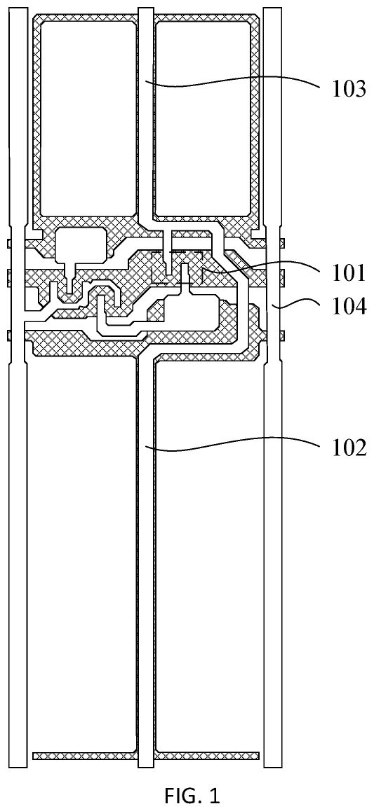

### DETAILED DESCRIPTION OF PREFERRED EMBODIMENTS

The embodiments of the present application are described in detail hereinafter. Examples of the described embodiments are given in the accompanying drawings. It should be noted that the following embodiments are intended to illustrate and interpret the present application, and shall not be construed as causing limitations to the present application. Similarly, the following embodiments are part of the embodiments of the present application and are not the whole embodiments, and all other embodiments obtained by those skilled in the art without making any inventive efforts are within the scope protected by the present application.

In the description of the present application, it should be understood that terms such as “upper,” “lower,” “front,” “rear,” “left,” “right,” “inside,” “outside,” as well as derivative thereof should be construed to refer to the orientation as shown in the drawings under discussion. These relative terms are for convenience of description and shall not be construed as causing limitations to the present application. Terms “first” and “second” are used simply for purpose of description and cannot be understood to mean or suggest relative importance or implicitly mean amount of the technical features. Therefore, features with terms “first” and “second” can mean or implicitly include one or more of the features.

Directing to a series of problems such as existence of a shared electrode line in a conventional pixel structure affecting an aperture ratio, white fog, a short circuit to a data line easily to occur, not easy to overhaul, etc., the present application provides a pixel structure that can mitigate these problems.

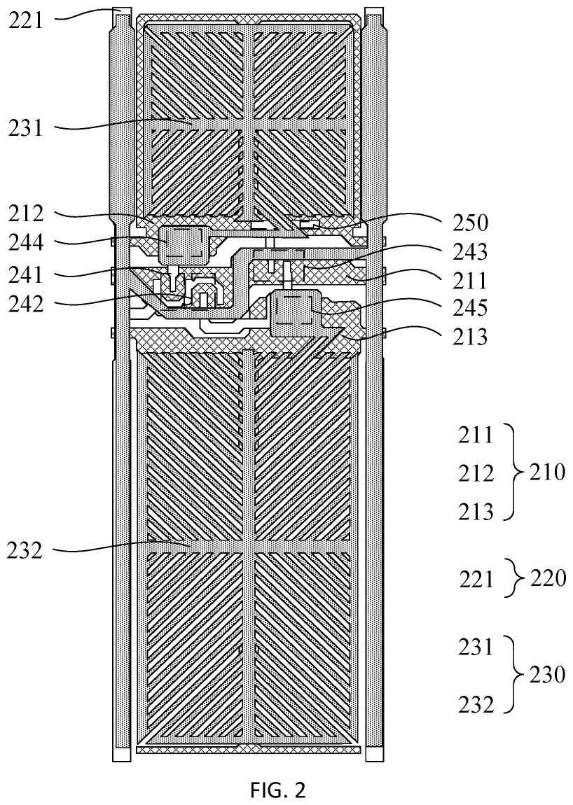

In one embodiment, as shown in FIG. 2, a pixel structure according to the present application includes:

A first metal layer 210 including a scan line 211, a gate of a first thin film transistor 241, a gate of a second thin film transistor 242, a gate of a third thin film transistor 243, and a gate common electrode line 212, wherein the gate common electrode line includes a first gate common electrode line 2121 and a second gate common electrode line 2122.

A second metal layer 220 including a data line 221, a source and a drain of the first thin film transistor 241, a source and a drain of the second thin film transistor 242, and a source and a drain of the third thin film transistor 243.

A pixel electrode layer 230 disposed on one side of the second metal layer away from the first metal layer and including a main pixel electrode 231 and a sub-pixel electrode 232.

Wherein, the main pixel electrode 231 is connected to the drain of the first thin film transistor 241, the sub-pixel electrode 232 is connected to the drain of the second thin film transistor 242 and the source of the third thin film transistor 243, and the drain of the third thin film transistor 243 is connected to the gate common electrode line 212 through a via hole 250.

The present embodiment provides a pixel structure, in which a drain of a third thin film transistor connected to a sub-pixel electrode is connected to a gate common electrode line, making an electrical signal passing through the third thin film transistor be directed away through the gate common electrode line, thereby decreasing voltage of a sub-pixel area, preventing a series of problems such as existence of a shared electrode line in a conventional pixel structure affecting an aperture ratio, white fog, a short circuit to a data line easily to occur, not easy to overhaul, etc., and simultaneously further mitigating a problem that a drain of a third thin film transistor is connected to a common electrode line on a color filter substrate in the conventional pixel structure, affecting the aperture ratio of a display panel.

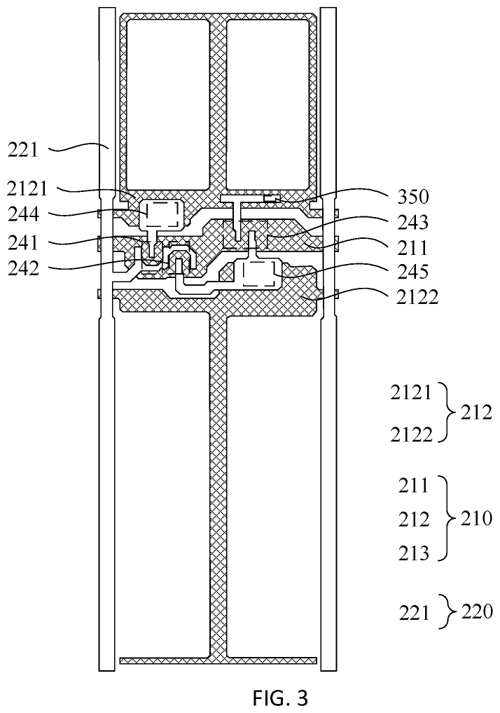

In one embodiment, as shown in FIG. 3, the drain of the third thin film transistor is connected to the first gate common electrode line.

Specifically, the first metal layer 210 is patterned to form the scan line 211, the first gate common electrode line 2121, and the second gate common electrode line 2122. The scan line 211 is disposed between the first gate common electrode line 2121 and the second gate common electrode line 2122, and insulated from the first gate common electrode line 2121 and the second gate common electrode line 2122. The scan line 211 has the gate of the first thin film transistor 241, the gate of the second thin film transistor 242, and the gate of the third thin film transistor 243. The first gate common electrode line 2121 has a first electrode plate of a first storage capacitor 244, and the second gate common electrode line 2122 has a first electrode plate of a second storage capacitor 245. The first gate common electrode line 2121 corresponds to a main pixel area, and the second gate common electrode line 2122 corresponds to a sub-pixel area.

The second metal layer 220 is patterned to form the data line 221, the source and the drain of the first thin film transistor 241, the source and the drain of the second thin film transistor 242, the source and the drain of the third thin film transistor 243, a second electrode plate of the first storage capacitor 244, and a second electrode plate of the second storage capacitor 245. The data line 221 is arranged as a one-piece with the source of the first thin film transistor 241 and the source of the second thin film transistor 242, the drain of the first thin film transistor 241 is arranged as a one-piece with the second electrode plate of the first storage capacitor 244, the drain of the second thin film transistor 242 is arranged as a one-piece with the second electrode plate of the second storage capacitor 245 and the source of the third thin film transistor 243, and the drain of the third thin film transistor 243 is connected to the first gate common electrode line 2121 through a via hole 350.

Through connecting a drain lead line of a third thin film transistor to a first gate common electrode line, the present embodiment makes an electrical signal passing through the third thin film transistor be directed away through the gate common electrode line, thereby decreasing voltage of a sub-pixel area, preventing a series of problems such as existence of a shared electrode line in a conventional pixel structure affecting aperture ratio, white fog, short circuiting to a data line easily to occur, not easy to overhaul, etc., and simultaneously further mitigating a problem that a drain of a third thin film transistor is connected to a common electrode line on a color filter substrate in the conventional pixel structure, affecting the aperture ratio of a display panel.

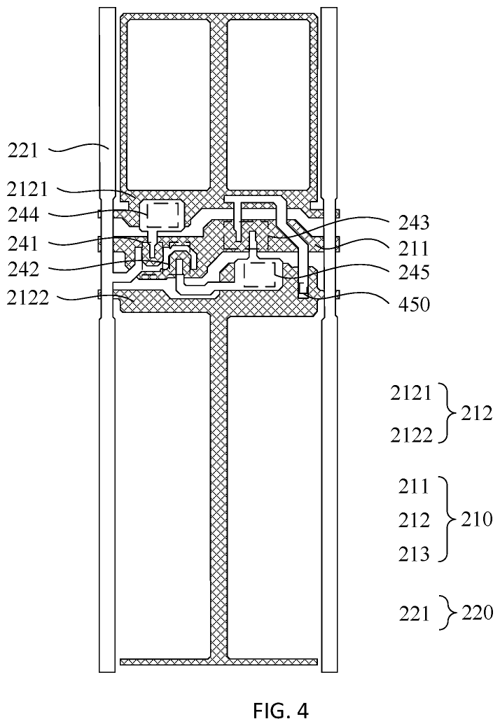

In another embodiment, as shown in FIG. 4, the drain of the third thin film transistor is connected to the second gate common electrode line.

Specifically, the first metal layer 210 is patterned to form the scan line 211, the first gate common electrode line 2121, and the second gate common electrode line 2122. The scan line 211 is disposed between the first gate common electrode line 2121 and the second gate common electrode line 2122, and insulated from the first gate common electrode line 2121 and the second gate common electrode line 2122. The scan line 211 includes thereon the gate of the first thin film transistor 241, the gate of the second thin film transistor 242, and the gate of the third thin film transistor 243. The first gate common electrode line 2121 includes thereon the first electrode plate of the first storage capacitor 244, and the second gate common electrode line 2122 includes thereon the first electrode plate of the second storage capacitor 245. The first gate common electrode line 2121 corresponds to the main pixel area, and the second gate common electrode line 2122 corresponds to the sub-pixel area.

The second metal layer 220 is patterned to form the data line 221, the source and the drain of the first thin film transistor 241, the source and the drain of the second thin film transistor 242, the source and the drain of the third thin film transistor 243, the second electrode plate of the first storage capacitor 244, and the second electrode plate of the second storage capacitor 245. The data line 221 is arranged as a one-piece with the source of the first thin film transistor 241 and the source of the second thin film transistor 242, the drain of the first thin film transistor 241 is arranged as a one-piece with the second electrode plate of the first storage capacitor 244, the drain of the second thin film transistor 242 is arranged as a one-piece with the second electrode plate of the second storage capacitor 245 and the source of the third thin film transistor 243, and the drain of the third thin film transistor 243 is connected by a connecting wire connected thereof to the second gate common electrode line 2122 through a via hole 450.

Through connecting a drain lead line of a third thin film transistor to a second gate common electrode line, the present embodiment makes an electrical signal passing through the third thin film transistor be directed away through the gate common electrode line, thereby decreasing voltage of a sub-pixel area, preventing a series of problems such as existence of a shared electrode line in a conventional pixel structure affecting an aperture ratio, white fog, not easy to overhaul, etc., and simultaneously further mitigating a problem that a drain of a third thin film transistor is connected to a common electrode line on a color filter substrate in the conventional pixel structure, affecting the aperture ratio of a display panel.

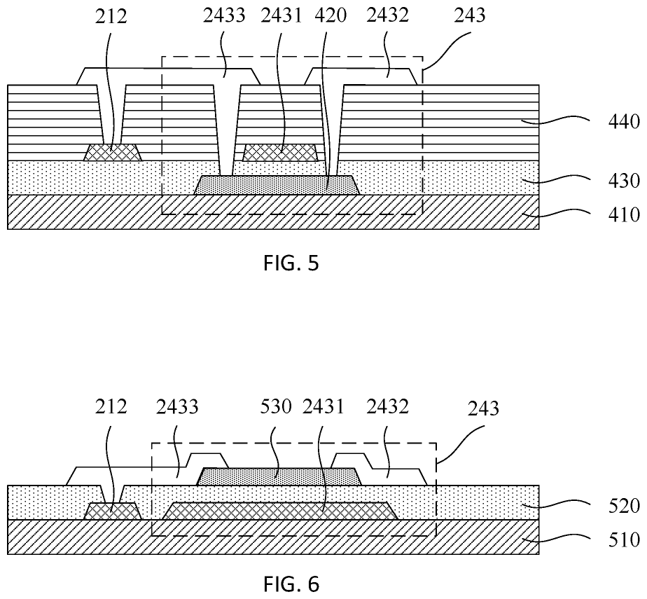

In one embodiment, as shown in FIG. 5, FIG. 5 is a first sectional schematic diagram of a pixel structure according to an embodiment of the present application (part of film layer structures not shown). The pixel structure includes a substrate 410, an active layer 420, a first insulating layer 430, a first metal layer 210, a second insulating layer 440, and a second metal layer 220. The active layer 420 is disposed on one side of the first metal layer 210 away from the second metal layer 220, the first insulating layer 430 is disposed between the first metal layer 210 and the active layer 420, and the second insulating layer 440 is disposed between the first metal layer 210 and the second metal layer 220.

The active layer 420 is patterned to form an active area of the third thin film transistor 243, and the active area includes a channel area and a doping area on two sides of the channel area. The first metal layer 210 is patterned to form the gate 2431 of the third thin film transistor 243 and the gate common electrode line 212. The second metal layer 220 is patterned to form the source 2432 and the drain 2433 of the third thin film transistor 243, and the source 2432 and the drain 2433 of the third thin film transistor 243 are separately connected to the doping area on two sides of the channel area through via holes running through the first insulating layer 430 and the second insulating layer 440. Meanwhile, the drain 2433 of the third thin film transistor 243 is further connected to the gate common electrode line 212 through a via hole running through the second insulating layer 440.

In another embodiment, as shown in FIG. 6, FIG. 6 is a second sectional schematic diagram of a pixel structure according to an embodiment of the present application (part of film layer structures not shown). The pixel structure includes a substrate 510, a first metal layer 210, an insulating layer 520, an active layer 530, and a second metal layer 220. The active layer 530 is disposed between the first metal layer 210 and the second metal layer 220, and the second metal layer 220 partially covers the active layer 530. The insulating layer 520 is disposed between the first metal layer 210 and the second metal layer 220 as well as the active layer 530.

The first metal layer 210 is patterned to form the gate 2431 of the third thin film transistor 243 and the gate common electrode line 212. The active layer 530 is patterned to form an active area of the third thin film transistor 243, and the active area includes a channel area and a doping area on two sides of the channel area. The second metal layer 220 is patterned to form the source 2432 and the drain 2433 of the third thin film transistor 243, and the source 2432 and the drain 2433 of the third thin film transistor 243 separately covers and connects to the doping area on two sides of the channel area. Meanwhile, the drain 2433 of the third thin film transistor 243 is further connected to the gate common electrode line 212 through a via hole running through the insulating layer 530.

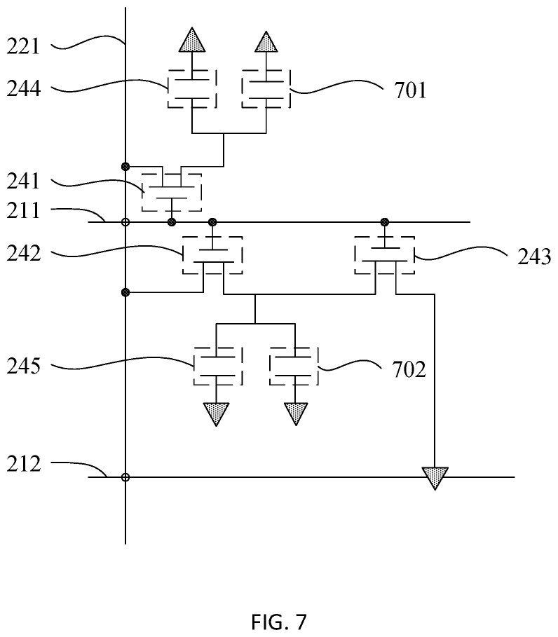

The present application further provides a pixel circuit, as shown in FIG. 7. The pixel circuit includes a first thin film transistor 241, a second thin film transistor 242, a third thin film transistor 243, a first storage capacitor 244, a main liquid crystal capacitor 701, a second storage capacitor 245, and a sub-liquid crystal capacitor 702. A drain of the first thin film transistor 241 is connected to a second electrode plate of the first storage capacitor 244 and a lower electrode plate of the main liquid crystal capacitor 701. A drain of the second thin film transistor 242 is connected to a second electrode plate of the second storage capacitor 245, a lower electrode plate of the sub-liquid crystal capacitor 702, and a source of the third thin film transistor 243. A gate of the first thin film transistor 241, a gate of the second thin film transistor 242, and a gate of the third thin film transistor 243 are connected to a same gate line 211 and input a same gate signal. A source of the first thin film transistor 241 and a source of the second thin film transistor 242 are connected to a same data line 221 and input a same data signal. A source of the third thin film transistor 243 is connected to the gate common electrode line and input a gate common electrical signal.

Wherein, the first thin film transistor 241 is a switch transistor that controls a main pixel area, and configured to control conducting of a circuit of the main pixel area. When the first thin film transistor 241 is conducting, the data signal of the data line 221 is input to the first storage capacitor 244 and the main liquid crystal capacitor 701 through the first thin film transistor 241 to charge the first storage capacitor 244 and the main liquid crystal capacitor 701. The second thin film transistor 242 is a switch transistor that controls a sub-pixel area, and the third thin film transistor 243 is a shared thin film transistor. When the second thin film transistor 242 and the third thin film transistor 243 are simultaneously conducting, after the data signal of the data line 221 passing through the second thin film transistor 242, a part of which is input to the second storage capacitor 245 and the sub-liquid crystal capacitor 702 to charge the second storage capacitor 245 and the sub-liquid crystal capacitor 702, while another part of which goes to the gate common electrode through the third thin film transistor 243.

The third thin film transistor 243 pulls down a voltage level of the sub-pixel area to make voltage of the sub-pixel area different from and lower than voltage of the main pixel area, make a deflection angle of liquid crystal molecules in the main pixel area and the sub-pixel area different, and further make brightness of the sub-pixel area lower than that of the main pixel area to improve a color shift phenomenon of a vertically aligned liquid crystal display panel at wide viewing angles.

Meanwhile, the present application further provides a display panel that includes a pixel structure, and the pixel structure includes: a first metal layer including a scan line, a gate of a first thin film transistor, a gate of a second thin film transistor, a gate of a third thin film transistor, and a gate common electrode line, wherein the gate common electrode line includes a first gate common electrode line and a second gate common electrode line; a second metal layer including a data line, a source and a drain of the first thin film transistor, a source and a drain of the second thin film transistor, and a source and a drain of the third thin film transistor; a pixel electrode layer disposed on one side of the second metal layer away from the first metal layer and including a main pixel electrode and a sub-pixel electrode; wherein the main pixel electrode is connected to the drain of the first thin film transistor, the sub-pixel electrode is connected to the drain of the second thin film transistor and the source of the third thin film transistor, and the drain of the third thin film transistor is connected to the gate common electrode line.

In one embodiment, the drain of the third thin film transistor is connected to the first gate common electrode line.

In another embodiment, the drain of the third thin film transistor is connected to the second gate common electrode line.

In one embodiment, the scan line is insulated from the gate common electrode line, and the data line is connected to the source of the first thin film transistor and the source of the second thin film transistor.

In one embodiment, the first metal layer further includes a first electrode plate of a first storage capacitor and a first electrode plate of a second storage capacitor, and the second metal layer further includes a second electrode plate of the first storage capacitor and a second electrode plate of the second storage capacitor, and wherein the drain of the first thin film transistor is connected to the second electrode plate of the first storage capacitor, and the drain of the second thin film transistor is connected to the second electrode plate of the second storage capacitor.

In one embodiment, the pixel structure further includes an active layer and an insulating layer, wherein the active layer is disposed between the first metal layer and the second metal layer, and the insulating layer is disposed between the first metal layer and the active layer.

In one embodiment, a via hole is formed in the insulating layer, and the drain of the third thin film transistor is connected to the gate common electrode line through the via hole.

In another embodiment, the pixel structure further includes an active layer, a first insulating layer, and a second insulating layer, wherein the active layer is disposed on one side of the first metal layer away from the second metal layer, the first insulating layer is disposed between the first metal layer and the active layer, and the second insulating layer is disposed between the first metal layer and the second metal layer.

In one embodiment, a via hole is formed in the second insulating layer, and the drain of the third thin film transistor is connected to the gate common electrode line through the via hole.

In one embodiment, the display panel further includes a pixel circuit, wherein the pixel circuit includes a first thin film transistor, a second thin film transistor, a third thin film transistor, a first storage capacitor, a first liquid crystal capacitor, a second storage capacitor, and a second liquid crystal capacitor, wherein a drain of the first thin film transistor is connected to the first storage capacitor and the first liquid crystal capacitor, and a drain of the second thin film transistor is connected to the second storage capacitor, the second liquid crystal capacitor, and a source of the third thin film transistor, and wherein a gate of the first thin film transistor, a gate of the second thin film transistor, and a gate of the third thin film transistor are connected to a same scan line and input a same scan electrical signal, a source of the first thin film transistor and a source of the second thin film transistor are connected to a same data line and input a same data electrical signal, and a source of the third thin film transistor is input a gate common signal.

It can be known according to the above-mentioned embodiments:

Embodiments of the present application provide a pixel structure, a pixel circuit, and a display panel. The pixel structure includes: a first metal layer including a scan line, a gate of a first thin film transistor, a gate of a second thin film transistor, a gate of a third thin film transistor, and a gate common electrode line, wherein the gate common electrode line includes a first gate common electrode line and a second gate common electrode line; a second metal layer including a data line, a source and a drain of the first thin film transistor, a source and a drain of the second thin film transistor, and a source and a drain of the third thin film transistor; a pixel electrode layer disposed on one side of the second metal layer away from the first metal layer and including a main pixel electrode and a sub-pixel electrode; wherein the main pixel electrode is connected to the drain of the first thin film transistor, the sub-pixel electrode is connected to the drain of the second thin film transistor and the source of the third thin film transistor, and the drain of the third thin film transistor is connected to the gate common electrode line through a via hole. The pixel structure prevents a series of problems such as existence of a shared electrode line in a conventional pixel structure affecting an aperture ratio, white fog, a short circuit to a data line easily to occur, not easy to overhaul, etc., and simultaneously further mitigates a problem that a drain of a third thin film transistor is connected to a common electrode line on a color filter substrate in the conventional pixel structure, affecting the aperture ratio of a display panel.

Although the present application has been explained in relation to its preferred embodiment, it does not intend to limit the present application. It is obvious to those skilled in the art having regard to this present application that other modifications of the exemplary embodiments beyond these embodiments specifically described here may be made without departing from the spirit of the application. Accordingly, such modifications are considered within the scope of the application as limited solely by the appended claims.

What is claimed is:

1. A pixel structure, comprising:
a first metal layer comprising a scan line, a gate of a first thin film transistor, a gate of a second thin film transistor, a gate of a third thin film transistor, and a gate common electrode line, wherein the gate common electrode line comprises a first gate common electrode line and a second gate common electrode line;
a second metal layer comprising a data line, a source and a drain of the first thin film transistor, a source and a drain of the second thin film transistor, and a source and a drain of the third thin film transistor;
a pixel electrode layer disposed on one side of the second metal layer away from the first metal layer and comprising a main pixel electrode and a sub-pixel electrode;
wherein the main pixel electrode is connected to the drain of the first thin film transistor, the sub-pixel electrode is connected to the drain of the second thin film transistor and the source of the third thin film transistor, and the drain of the third thin film transistor is connected to the gate common electrode line.

2. The pixel structure as claimed in claim 1, wherein the drain of the third thin film transistor is connected to the first gate common electrode line.

3. The pixel structure as claimed in claim 1, wherein the drain of the third thin film transistor is connected to the second gate common electrode line.

4. The pixel structure as claimed in claim 1, wherein the scan line is insulated from the gate common electrode line, and the data line is connected to the source of the first thin film transistor and the source of the second thin film transistor.

5. The pixel structure as claimed in claim 1, wherein the first metal layer comprises a first electrode plate of a first storage capacitor and a first electrode plate of a second storage capacitor, and the second metal layer comprises a second electrode plate of the first storage capacitor and a second electrode plate of the second storage capacitor, and wherein the drain of the first thin film transistor is connected to the second electrode plate of the first storage capacitor, and the drain of the second thin film transistor is connected to the second electrode plate of the second storage capacitor.

6. The pixel structure as claimed in claim 1, comprising an active layer and an insulating layer, wherein the active layer is disposed between the first metal layer and the second metal layer, and the insulating layer is disposed between the first metal layer and the active layer.

7. The pixel structure as claimed in claim 6, wherein a via hole is formed in the insulating layer, and the drain of the third thin film transistor is connected to the gate common electrode line through the via hole.

8. The pixel structure as claimed in claim 1, comprising an active layer, a first insulating layer, and a second insulating layer, wherein the active layer is disposed on one side of the first metal layer away from the second metal layer, the first insulating layer is disposed between the first metal layer and the active layer, and the second insulating layer is disposed between the first metal layer and the second metal layer.

9. The pixel structure as claimed in claim 7, wherein a via hole is formed in the second insulating layer, and the drain of the third thin film transistor is connected to the gate common electrode line through the via hole.

10. A pixel circuit, comprising a first thin film transistor, a second thin film transistor, a third thin film transistor, a first storage capacitor, a first liquid crystal capacitor, a second storage capacitor, and a second liquid crystal capacitor, wherein a drain of the first thin film transistor is connected to the first storage capacitor and the first liquid crystal capacitor, and a drain of the second thin film transistor is connected to the second storage capacitor, the second liquid crystal capacitor, and a source of the third thin film transistor, and wherein a gate of the first thin film transistor, a gate of the second thin film transistor, and a gate of the third thin film transistor are connected to a same scan line and input a same scan electrical signal, a source of the first thin film transistor and a source of the second thin film transistor are connected to a same data line and input a same data electrical signal, and a source of the third thin film transistor is input a gate common signal.

11. A display panel, comprising a pixel structure, wherein the pixel structure comprises:
a first metal layer comprising a scan line, a gate of a first thin film transistor, a gate of a second thin film transistor, a gate of a third thin film transistor, and a gate common electrode line, wherein the gate common electrode line comprises a first gate common electrode line and a second gate common electrode line;
a second metal layer comprising a data line, a source and a drain of the first thin film transistor, a source and a drain of the second thin film transistor, and a source and a drain of the third thin film transistor;
a pixel electrode layer disposed on one side of the second metal layer away from the first metal layer and comprising a main pixel electrode and a sub-pixel electrode;
wherein the main pixel electrode is connected to the drain of the first thin film transistor, the sub-pixel electrode is connected to the drain of the second thin film transistor and the source of the third thin film transistor, and the drain of the third thin film transistor is connected to the gate common electrode line.

12. The display panel as claimed in claim 11, wherein the drain of the third thin film transistor is connected to the first gate common electrode line.

13. The display panel as claimed in claim 11, wherein the drain of the third thin film transistor is connected to the second gate common electrode line.

14. The display panel as claimed in claim 11, wherein the scan line is insulated from the gate common electrode line, and the data line is connected to the source of the first thin film transistor and the source of the second thin film transistor.

15. The display panel as claimed in claim 11, wherein the first metal layer comprises a first electrode plate of a first storage capacitor and a first electrode plate of a second storage capacitor, and the second metal layer comprises a second electrode plate of the first storage capacitor and a second electrode plate of the second storage capacitor, and wherein the drain of the first thin film transistor is connected to the second electrode plate of the first storage capacitor, and the drain of the second thin film transistor is connected to the second electrode plate of the second storage capacitor.

16. The display panel as claimed in claim 11, wherein the pixel structure comprises an active layer and an insulating layer, wherein the active layer is disposed between the first metal layer and the second metal layer, and the insulating layer is disposed between the first metal layer and the active layer.

17. The display panel as claimed in claim 16, wherein a via hole is formed in the insulating layer, and the drain of the third thin film transistor is connected to the gate common electrode line through the via hole.

18. The display panel as claimed in claim 11, wherein the pixel structure comprises an active layer, a first insulating layer, and a second insulating layer, wherein the active layer is disposed on one side of the first metal layer away from the second metal layer, the first insulating layer is disposed between the first metal layer and the active layer, and the second insulating layer is disposed between the first metal layer and the second metal layer.

19. The display panel as claimed in claim 17, wherein a via hole is formed in the second insulating layer, and the drain of the third thin film transistor is connected to the gate common electrode line through the via hole.

20. The display panel as claimed in claim 11, comprising a pixel circuit, wherein the pixel circuit comprises a first thin film transistor, a second thin film transistor, a third thin film transistor, a first storage capacitor, a first liquid crystal capacitor, a second storage capacitor, and a second liquid crystal capacitor, wherein a drain of the first thin film transistor is connected to the first storage capacitor and the first liquid crystal capacitor, and a drain of the second thin film transistor is connected to the second storage capacitor, the second liquid crystal capacitor, and a source of the third thin film transistor, and wherein a gate of the first thin film transistor, a gate of the second thin film transistor, and a gate of the third thin film transistor are connected to a same scan line and input a same scan electrical signal, a source of the first thin film transistor and a source of the second thin film transistor are connected to a same data line and input a same data electrical signal, and a source of the third thin film transistor is input a gate common signal.
